(19) United States
(12) Patent Application Publication
(10) Pub. No.: US 2026/0081155 A1
(43) Pub. Date: Mar. 19, 2026

(54) POSITIVE ELECTRODE ACTIVE MATERIAL, ELECTRODE, AND BATTERY

(71) Applicant: TOYOTA JIDOSHA KABUSHIKI KAISHA, Toyota-shi (JP)

(72) Inventors: Takanori MAHARA, Toyota-shi (JP); Tatsuya Eguchi, Kariya-shi (JP); Takeshi Kimijima, Kariya-shi (JP)

(73) Assignee: TOYOTA JIDOSHA KABUSHIKI KAISHA, Toyota-shi (JP)

(21) Appl. No.: 19/318,869

(22) Filed: Sep. 4, 2025

(30) Foreign Application Priority Data
Sep. 18, 2024 (JP) 2024-161037

(51) Int. Cl. H01M 4/58; C01B 25/45

(52) U.S. Cl. CPC H01M 4/5825; C01B 25/45; C01P 2002/50; C01P 2004/50; C01P 2004/51; C01P 2004/64; C01P 2006/40

(57) ABSTRACT

A positive electrode active material comprises powder. The powder includes secondary particles. Each of the secondary particles includes primary particles. Each of the primary particles includes an olivine-type phosphate compound. In an SEM image of the powder, a proportion of the secondary particles each having an open pore to the secondary particles each having a maximum Feret diameter of 5 μm or more is 40% or more.

### CROSS REFERENCE TO RELATED APPLICATIONS

This nonprovisional application is based on Japanese Patent Application No. 2024-161037 filed on Sep. 18, 2024, with the Japan Patent Office, the entire contents of which are hereby incorporated by reference.

### BACKGROUND

### Field

The present disclosure relates to a positive electrode active material, an electrode, and a battery.

### Description of the Background Art

Japanese Patent Laying-Open No. 2024-35800 discloses a positive electrode active material layer in which the positive electrode active material is a compound having an olivine-type crystal structure and the porosity is 40% or less.

### SUMMARY

Typically, positive electrode active material is in powder form (a group of secondary particles). Inside a battery, positive electrode active material is impregnated with electrolyte solution. From the viewpoint of battery productivity, rate properties, and the like, there is a demand for improving the rate of impregnation of positive electrode active material with electrolyte solution (hereinafter also called “a liquid impregnation rate”).

As a positive electrode active material, olivine-type phosphate compounds have been developed. Olivine-type phosphate compounds tend to have low electrical conductivity. Because of this, conventionally, attempts have been made to improve the electrical conductivity by reducing the size of primary particles constituting secondary particles (granules). However, there is room for improvement in the liquid impregnation rate.

An object of the present disclosure is to improve the liquid impregnation rate.

Hereinafter, the technical configuration and effects of the present disclosure will be described. It should be noted that the action mechanism according to the present disclosure includes presumption. The action mechanism does not limit the technical scope of the present disclosure.

1. An aspect of the present disclosure is a positive electrode active material. The positive electrode active material comprises powder. The powder includes secondary particles. Each of the secondary particles includes primary particles. Each of the primary particles includes an olivine-type phosphate compound. In a scanning electron microscope (SEM) image of the powder, a proportion of the secondary particles each having an open pore to the secondary particles each having a maximum Feret diameter of 5 μm or more is 40% or more.

Hereinafter, the “proportion of the secondary particles each having an open pore to the secondary particles each having a maximum Feret diameter of 5 μm or more” is also called “a first proportion”. “Open pore” refers to a hollow portion that is open to the outside of the secondary particle. The sizes of the secondary particles of the powder may vary to some extent. When the first proportion is 40% or more, the liquid impregnation rate is expected to be improved. The reason may be that the open pores of the secondary particles with sizes of 5 μm or more tend to provide suitable pathways for permeation.

2. The positive electrode active material according to “1” above may include the following configuration, for example. In the scanning electron microscope image of the powder, a proportion of the secondary particles each having an open pore to the secondary particles each having a maximum Feret diameter of 10 μm or more is 70% or more.

Hereinafter, the “proportion of the secondary particles each having an open pore to the secondary particles each having a maximum Feret diameter of 10 μm or more” is also called “a second proportion”. When the second proportion is 70% or more, the liquid impregnation rate is expected to be improved. The reason may be that the open pores of the secondary particles with sizes of 10 μm or more tend to provide suitable pathways for permeation.

3. The positive electrode active material according to “1” or “2” above may include the following configuration, for example. In a scanning electron microscope image of a cross section of the powder, a proportion of hollow particles each having a hollow portion inside thereof to the secondary particles each having a maximum Feret diameter of 5 μm or more is 40% or more.

Hereinafter, the “proportion of hollow particles each having a hollow portion inside thereof to the secondary particles each having a maximum Feret diameter of 5 μm or more” is also called “a third proportion”. In a cross-sectional sample of the powder, a secondary particle having an open pore may be observed as a hollow particle. It is conceivable that the proportion of hollow particles in a cross-sectional SEM image of the powder, namely “the third proportion”, agrees well with the first proportion in a surface SEM image of the powder.

4. The positive electrode active material according to any one of “1” to “3” above may include the following configuration, for example. In a volume-based particle size distribution measured by laser diffraction, D10 is less than 5 μm and D90 is more than 10 μm.

It is conceivable that the range of D10 to D90 in the particle size distribution is the main part of the particle size distribution. When the secondary particles constituting the main part of the particle size distribution have open pores, the liquid impregnation rate is expected to be improved.

5. The positive electrode active material according to any one of “1” to “4” above may include the following configuration, for example. A ratio of a pore diameter of the open pore to the maximum Feret diameter of the secondary particle is 0.1 or more.

6. The positive electrode active material according to any one of “1” to “5” above may include the following configuration, for example. A maximum Feret diameter of the primary particle is from 10 to 90 nm.

7. The positive electrode active material according to any one of “1” to “6” above may include the following configuration, for example. The olivine-type phosphate compound includes lithium manganese phosphate.

As an olivine-type phosphate compound, lithium iron phosphate (which may be abbreviated as “LFP” hereinafter) has been developed. However, due to its low discharge voltage, LFP has an issue in terms of energy density. As compared to LFP, lithium manganese phosphate (which may be abbreviated as “LMP” hereinafter) is expected to have high discharge voltage. When the positive electrode active material includes LMP, output properties are expected to be enhanced, for example.

8. An aspect of the present disclosure is an electrode. The electrode comprises a positive electrode layer. The positive electrode layer includes the positive electrode active material according to any one of “1” to “7”.

The positive electrode layer may also be called “a positive electrode active material layer”, “a positive electrode composite material layer”, and the like. When the liquid impregnation rate of the positive electrode active material is fast, battery productivity is expected to be enhanced. It should be noted that “electrode” may be either “a monopolar electrode (a positive electrode)” or “a bipolar electrode” as long as it includes a positive electrode layer.

9. An aspect of the present disclosure is a battery. The battery comprises the electrode according to “8” above and an electrolyte solution.

When the liquid impregnation rate of the positive electrode active material is fast, it is expected that the electrolyte solution can permeate throughout the entire positive electrode layer. As a result of the permeation of the electrolyte solution, rate properties of the battery are expected to be enhanced, for example.

10. The battery according to “9” above may include the following configuration, for example. The battery has a bipolar structure.

The bipolar structure may be formed by stacking bipolar electrodes together. With the bipolar structure, output properties are expected to be enhanced, for example.

In the following, an embodiment of the present disclosure (which may be simply called “the present embodiment” hereinafter) and an example of the present disclosure (which may be simply called “the present example” hereinafter) will be described. It should be noted that neither the present embodiment nor the present example limits the technical scope of the present disclosure. The present embodiment and the present example are illustrative in any respect. The present embodiment and the present example are non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a first conceptual view illustrating a positive electrode active material according to the present embodiment.

FIG. 2 is a second conceptual view illustrating a positive electrode active material according to the present embodiment.

FIG. 3 is a conceptual view illustrating a secondary particle according to the present embodiment.

FIG. 4 is a schematic flowchart illustrating a method of producing a positive electrode active material according to the present embodiment.

FIG. 5 is a schematic perspective view illustrating a battery according to the present embodiment.

FIG. 6 is a schematic view of a cross section cut along the line VI-VI in FIG. 5.

FIG. 7 is a table showing experiment results.

FIG. 8 is a temperature profile during calcination.

### DESCRIPTION OF THE PREFERRED EMBODIMENTS

### Terms and Phrases

Expressions such as “comprise”, “include”, and “have”, and other similar terms are open-ended expressions. In the configuration expressed by an open-ended expression, in addition to an essential component, an additional component may or may not be further included. The expression “consist of” is a closed-end expression. However, even in a configuration that is expressed by a closed-end expression, impurities present under ordinary circumstances as well as an additional element irrelevant to the technique of interest may be included. The expression “consist essentially of” is a semiclosed-end expression. A configuration expressed by a semiclosed-end expression tolerates addition of an element that does not substantially affect the fundamental, novel features of the technique of interest.

Expressions such as “may” and “can” are not intended to mean “must” (obligation) but rather mean “there is a possibility” (tolerance).

Regarding a plurality of steps, operations, processes, and the like that are included in various methods, the order for implementing those things is not limited to the described order, unless otherwise specified. For example, a plurality of steps may proceed simultaneously. For example, a plurality of steps may be implemented in reverse order.

Expressions such as “first” and “second” are used solely for differentiating a plurality of elements from each other. Such expressions do not limit the scope of these elements. For example, these expressions are independent of the order and the significance of these elements.

For example, the expression “at least one of A and B” includes “A or B” and “A and B”. “At least one of A and B” may also be expressed as “A and/or B”.

Any geometric term should not be interpreted solely in its exact meaning. Examples of geometric terms include “parallel”, “vertical”, “orthogonal”, and the like. For example, as long as substantially the same or similar functions are obtained, the relative direction, angle, distance, and the like may vary. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. A part of a given configuration may have been omitted.

A singular form may also include its plural meaning, unless otherwise specified. For example, a particle may mean a plurality of particles, a group of particles, and a powdery and granular material.

A numerical range such as “from m to n %” includes both the upper limit and the lower limit, unless otherwise specified. That is, “from m to n %” means a numerical range of “not less than m % and not more than n %”. Moreover, “not less than m % and not more than n %” includes “more than m % and less than n %”. Each of “not less than” and “not more than” is represented by an inequality symbol with an equality symbol, e.g., “≤, ≥”. Each of “more than” and “less than” is represented by an inequality symbol without an equality symbol, e.g., “<, >”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean±5%, ±3%, ±1%, and/or the like, for example. Each numerical value may be an approximate value that can vary depending on the implementation configuration of the technique of interest. Each numerical value may be expressed in significant figures. Unless otherwise specified, each measured value may be the average value obtained by multiple rounds of measurement. The number of rounds of measurement may be 3 or more, or may be 5 or more, or may be 10 or more. Generally, the greater the number of rounds of measurement is, the more reliable the average value is expected to be. Each measured value may be rounded off based on the number of the significant figures. Each measured value may include an error occurring due to the identification limit of the measurement apparatus, for example.

An apparatus and/or the like used for measurement of various values is merely an example. It is possible to use a product similar to the apparatus and/or the like presented as an example. When a similar product is used, the measurement conditions may be adjusted to be suitable for the apparatus.

The proportion of secondary particles each having an open pore (first proportion, second proportion) is measured by the procedure described below. Powder (positive electrode active material) is sprinkled onto the surface of a piece of carbon tape. The powder on the carbon tape is examined with an SEM, and thereby a surface SEM image of the powder is obtained. The magnification for the examination is adjusted in such a way that 30 or more secondary particles are contained in the field of view. The magnification for the examination may be adjusted within the range of 5000 to 15000 times, for example. The magnification may be about 10000 times, for example. In a plurality of fields of view (for example, in about 5 fields of view), a total of 30 secondary particles each having a maximum Feret diameter of 5 μm or more are randomly selected. Among the selected 30 secondary particles, secondary particles each having an open pore are counted. The number of the secondary particles each having an open pore is divided by 30, and thereby “a first proportion” is determined. Among the selected 30 secondary particles, secondary particles each having a maximum Feret diameter of 10 μm or more are counted. Furthermore, among the secondary particles each having a maximum Feret diameter of 10 μm or more, secondary particles each having an open pore are counted. The number of the secondary particles each having an open pore is divided by the total number of the secondary particles each having a maximum Feret diameter of 10 μm or more, and thereby “a second proportion” is determined.

A cross-sectional sample of the powder may be prepared to measure the proportion of hollow particles in the powder (third proportion). The procedure of the measurement is as described below. In a mixture (10 g) of an epoxy resin (under the trade name of “EPOTEX JP”, manufactured by Nisshin-EM) as a main agent and a curing agent, 1 g of the powder (positive electrode active material) is dispersed to form a dispersion. The resulting dispersion is stirred and mixed for 1 minute with a mixer (under the trade name of “Awatori-Rentaro” (THINKY MIXER), manufactured by Thinky). The dispersion is subjected to vacuum defoaming. After vacuum defoaming, the dispersion is filled into a round tubular vessel made of resin. The dispersion is left for 1 day for curing of the epoxy resin. After curing, the cured product is subjected to wet polishing, and thereby an even and smooth cross section is formed. The even and smooth cross section is examined with an SEM, and thereby a cross-sectional SEM image is obtained. In a plurality of fields of view (for example, in about 5 fields of view), a total of 30 secondary particles each having a maximum Feret diameter of 5 μm or more are randomly selected. Among the selected 30 secondary particles, hollow particles are counted. The number of the hollow particles is divided by 30, and thereby “a third proportion” is determined. Furthermore, among secondary particles each having a maximum Feret diameter of 10 μm or more, hollow particles are counted. The number of the hollow particles is divided by the total number of the secondary particles each having a maximum Feret diameter of 10 μm or more, and thereby “a fourth proportion” is determined.

The “maximum Feret diameter” of a particle refers to the length of the long side of a circumscribing rectangular (an oblong or a square) that circumscribes the particle. When the circumscribing rectangular is square, the length of the long side refers to the length of a side. The “pore diameter” of an open pore refers to the maximum Feret diameter of the opening of the open pore. The maximum Feret diameter of the primary particle may be measured in a transmission electron microscopy (TEM) image, for example.

“D10” refers to a particle size in volume-based particle size distribution (cumulative distribution) at which the cumulative value reaches 10%. “D50” refers to a particle size in the particle size distribution at which the cumulative value reaches 50%. “D90” refers to a particle size in the particle size distribution at which the cumulative value reaches 90%. The volume-based particle size distribution is measured with a laser-diffraction particle size distribution analyzer.

A stoichiometric composition formula represents a typical example of a compound. A compound may have a non-stoichiometric composition. For example, “Al₂O₃” is not limited to a compound where the ratio in amount of substance (the molar ratio) is “Al/O=2/3”. “Al₂O₃” represents a compound that includes Al and O in any ratio in amount of substance, unless otherwise specified. For example, the compound may be doped with a trace element. Some of Al and/or O may be replaced by another element.

The chemical composition of a compound may be measured by inductively coupled plasma atomic emission spectroscopy (ICP-AES). A sample (for example, a positive electrode active material) in an amount of 0.1 g is dissolved in a mixed acid (10 ml) of hydrochloric acid and sulfuric acid to prepare a sample solution. The sample solution is diluted to a proper concentration with the use of a volumetric flask. After dilution, composition analysis is carried out with an ICP-AES apparatus. For example, a product under the trade name “PS3520 UVDD II (manufactured by Hitachi High-Tech Science)” and/or the like may be used.

“Derivative” refers to a compound that is derived from its original compound by at least one partial modification selected from the group consisting of functional group introduction, atom replacement, oxidation, reduction, and other chemical reactions. The position of modification may be one position, or may be a plurality of positions. “Substituent” may include at least one selected from the group consisting of alkyl group, alkenyl group, alkynyl group, cycloalkyl group, unsaturated cycloalkyl group, aromatic group, heterocyclic group, halogen atom (F, Cl, Br, I, etc.), OH group, SH group, CN group, SCN group, OCN group, nitro group, alkoxy group, unsaturated alkoxy group, amino group, alkylamino group, dialkylamino group, aryloxy group, acyl group, alkoxycarbonyl group, acyloxy group, aryloxycarbonyl group, acylamino group, alkoxycarbonylamino group, aryloxy carbonylamino group, sulfonylamino group, sulfamoyl group, carbamoyl group, alkylthio group, arylthio group, sulfonyl group, sulfinyl group, ureido group, phosphoramide group, sulfo group, carboxy group, hydroxamic acid group, sulfino group, hydrazino group, imino group, silyl group, and the like, for example. These substituents may be further substituted. When there are two or more substituents, these substituents may be the same as one another or may be different from each other. A plurality of substituents may be bonded together to form a ring.

### —Positive Electrode Active Material—

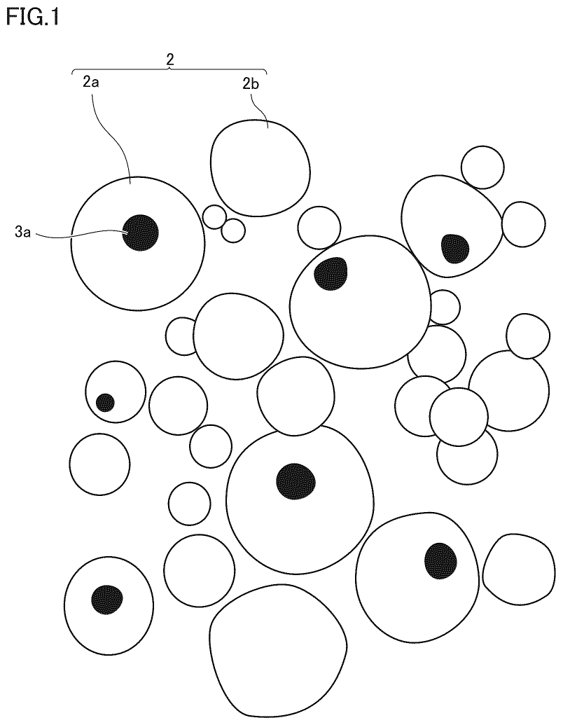

FIG. 1 is a first conceptual view illustrating a positive electrode active material according to the present embodiment. For example, FIG. 1 may be produced by tracing a surface SEM image of the powder. The positive electrode active material comprises powder. The powder includes a plurality of secondary particles 2. A secondary particle 2a has an open pore 3a. A secondary particle 2b does not have open pore 3a. Secondary particle 2b that does not look to have open pore 3a in an SEM image may have open pore 3a at a position that is invisible in the SEM image. Regardless of this, in the present embodiment, determination of the presence or absence of open pore 3a is based solely on the appearance in an SEM image.

The proportion of secondary particles 2a each having open pore 3a to secondary particles 2 each having a maximum Feret diameter of 5 μm or more, namely “the first proportion”, is 40% or more. The first proportion may be 42% or more, or 44% or more, or 47% or more, or 50% or more, or 55% or more, or 60% or more, for example. The first proportion may be 60% or less, or 55% or less, or 50% or less, or 47% or less, or 44% or less, or 42% or less, for example. The greater the first proportion is, the more enhanced the liquid impregnation rate is expected to be. However, as the first proportion increases, the packing properties of the positive electrode active material (electrode density) may degrade, for example. When the first proportion is 60% or less, for example, the liquid impregnation rate and the packing properties tend to be well balanced.

The proportion of secondary particles 2a each having open pore 3a to secondary particles 2 each having a maximum Feret diameter of 10 μm or more, namely “the second proportion”, may be 67% or more. The second proportion may be 70% or more, or 74% or more, or 78% or more, or 80% or more, or 84% or more, or 88% or more, or 92% or more, for example. The second proportion may be 100% or less, or 94% or less, or 92% or less, or 88% or less, or 84% or less, or 80% or less, or 78% or less, for example. When the second proportion is 70% or more, the liquid impregnation rate is expected to be enhanced even more.

The average maximum Feret diameter of 30 secondary particles may be 5 μm or more, or 6 μm or more, or 7 μm or more, or 8 μm or more, or 9 μm or more, for example. The average maximum Feret diameter may be 12 μm or less, or 11 μm or less, or 10 μm or less, for example.

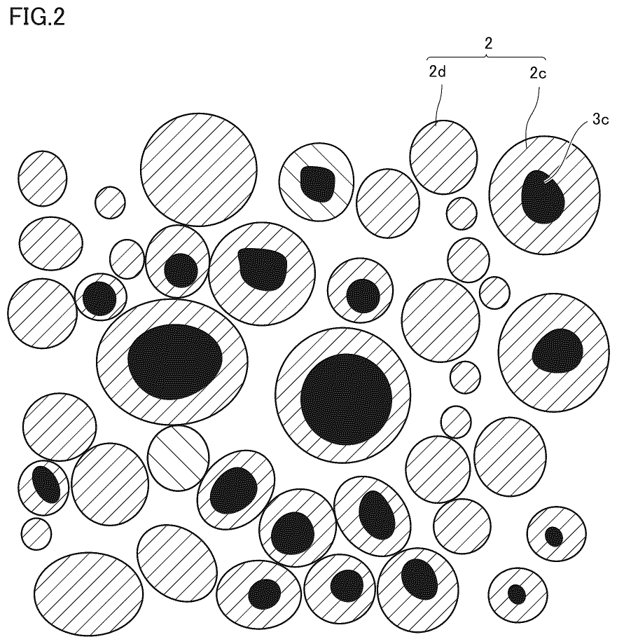

FIG. 2 is a second conceptual view illustrating a positive electrode active material according to the present embodiment. For example, FIG. 2 may be produced by tracing a cross-sectional SEM image of the powder. In a cross section of the powder, the powder includes a plurality of secondary particles 2. Secondary particles 2 include hollow particles 2c and solid particles 2d. Hollow particle 2c has a hollow portion 3c inside the particle. Solid particle 2d does not have hollow portion 3c inside the particle. Determination of the presence or absence of hollow portion 3c is also solely based on the appearance in a cross-sectional SEM image. It is highly probable that hollow particle 2c corresponds to secondary particle 2a (with open pore 3a). It is highly probable that solid particle 2d corresponds to secondary particle 2b (without open pore 3a). It is conceivable that the proportion of hollow particles 2c to secondary particles 2 each having a maximum Feret diameter of 5 μm or more (the third proportion) agrees well with the first proportion of the powder. In other words, the third proportion may be 40% or more, for example. The third proportion may be 42% or more, or 44% or more, or 47% or more, or 50% or more, or 55% or more, or 60% or more, for example. The third proportion may be 60% or less, or 55% or less, or 50% or less, or 47% or less, or 44% or less, or 42% or less, for example.

The proportion of hollow particles 2c to secondary particles 2 each having a maximum Feret diameter of 10 μm or more, namely “the fourth proportion”, may be 67% or more, for example. The fourth proportion may be 70% or more, or 74% or more, or 78% or more, or 80% or more, or 84% or more, or 88% or more, or 92% or more, for example. The fourth proportion may be 100% or less, or 94% or less, or 92% or less, or 88% or less, or 84% or less, or 80% or less, or 78% or less, for example.

In the volume-based particle size distribution of the powder, the relationships of “D10<5 μm” and “10 μm<D90” may be satisfied, for example. D10 may be 4 μm or less, or 3 μm or less, or 2 μm or less, for example. D10 may be 1 μm or more, for example. D90 may be 15 μm or more, or 20 μm or more, or 25 μm or more, or 30 μm or more, or 35 μm or more, or 40 μm or more, for example. D90 may be 50 μm or less, or 40 μm or less, or 35 μm or less, for example. D50 may be 5 μm or more, or 6 μm or more, or 7 μm or more, or 8 μm or more, or 9 μm or more, for example. D50 may be 12 μm or less, or 11 μm or less, or 10 μm or less, for example.

Secondary particle 2 may have any outer shape. Secondary particle 2 may have a spherical outer shape. When secondary particle 2 is spherical, packing properties are expected to be enhanced, for example. The sphericity of secondary particle 2 may be 0.85 or more, or 0.90 or more, or 0.95 or more, for example. The sphericity of secondary particle 2 may be 1 or less, or 0.95 or less, or 0.90 or less, for example. “Sphericity” refers to the circularity in a surface SEM image (a two-dimensional image). The sphericity (circularity) is determined by the following equation.

$$ψ = 4 π S / {L}^{2}$$

ψ: Sphericity (circularity)
π: Circular constant
S: Cross-sectional area of secondary particle 2 (the area of a region surrounded by the contour of secondary particle 2)
L: Perimeter of secondary particle 2 (the length of the contour of secondary particle 2)

The sphericity refers to the arithmetic mean of 30 secondary particles 2. The sphericity of 30 secondary particles 2 is measured regardless of the presence or absence of open pore 3a.

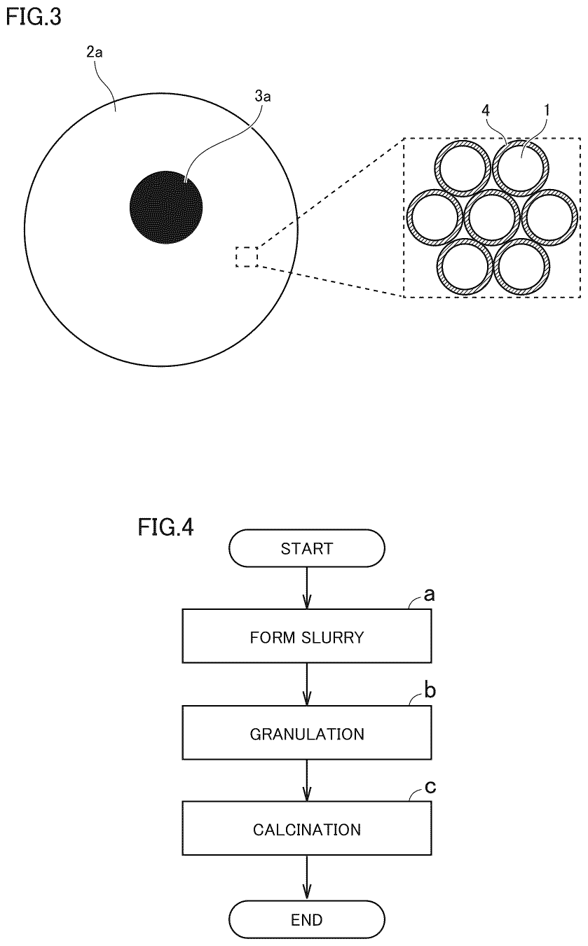

FIG. 3 is a conceptual view illustrating a secondary particle according to the present embodiment. Secondary particle 2a is a group of primary particles 1. In other words, secondary particle 2a includes a plurality of primary particles 1. The same applies to secondary particle 2b (not illustrated).

The maximum Feret diameter of primary particle 1 may be from 10 to 90 nm, for example. The maximum Feret diameter of primary particle 1 may be 20 nm or more, or 30 nm or more, or 40 nm or more, or 50 nm or more, or 60 nm or more, or 70 nm or more, or 80 nm or more, for example. The maximum Feret diameter of primary particle 1 may be 80 nm or less, or 60 nm or less, for example. The maximum Feret diameter of primary particle 1 refers to the arithmetic mean of 30 primary particles 1.

The ratio of the pore diameter of open pore 3a to the maximum Feret diameter of secondary particle 2a may be 0.1 or more, for example. This ratio may be 0.2 or more, or 0.3 or more, or 0.4 or more, or 0.5 or more, or 0.6 or more, or 0.7 or more, or 0.8 or more, for example. This ratio may be 0.9 or less, or 0.8 or less, or 0.7 or less, or 0.6 or less, or 0.5 or less, or 0.4 or less, or 0.3 or less, or 0.2 or less, for example.

To the surface of primary particle 1, a carbon layer 4 may be adhered. Carbon layer 4 includes carbon (C). The amount of adhered carbon layer 4 in mass fraction relative to secondary particle 2 may be 0.1% or more, or 0.5% or more, or 1% or more, or 2% or more, or 3% or more, or 4% or more, for example. The amount of adhered carbon layer 4 in mass fraction relative to secondary particle 2 may be 5% or less, or 4% or less, or 3% or less, for example.

Each of primary particles 1 includes an olivine-type phosphate compound. “Olivine-type” refers to a crystal structure belonging to the space group Pnma. The space group is identified by X-ray diffraction (XRD) measurement of the powder. Primary particle 1 may be a single-phase compound, for example. As long as it includes an olivine-type crystalline phase, primary particle 1 may further include a phase that belongs to another space group. Primary particle 1 may further include an amorphous phase and/or the like, for example.

The olivine-type phosphate compound may include lithium iron phosphate (LFP), lithium manganese phosphate (LMP), and/or the like, for example. In LMP, part of manganese (Mn) may be replaced by iron (Fe). Fe-replaced LMP is also called lithium manganese iron phosphate (LMFP). LMP may have a composition represented by the following general formula, for example.

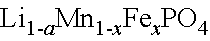

For example, the relationship of −0.5≤a≤0.5 may be satisfied. The Fe-replacing amount (x) may be 0 or more, or 0.05 or more, or 0.1 or more, or 0.2 or more, or 0.3 or more, or 0.4 or more, or 0.5 or more, or 0.6 or more, or 0.7 or more, or 0.8 or more, or 0.9 or more, for example. The Fe-replacing amount (x) may be 0.9 or less, or 0.8 or less, or 0.7 or less, or 0.6 or less, or 0.5 or less, or 0.4 or less, or 0.3 or less, or 0.2 or less, or 0.1 or less, for example.

The LMP may be doped with an element (a dopant) other than lithium (Li), Mn, Fe, phosphorus (P), and oxygen (O). The doping amount (the fraction in amount of substance relative to the amount of substance of Li) may be from 0.01 to 0.1, for example. The dopant may include at least one selected from the group consisting of boron (B), nitrogen (N), a halogen, silicon (Si), sodium (Na), magnesium (Mg), aluminum (Al), chromium (Cr), scandium (Sc), titanium (Ti), vanadium (V), cobalt (Co), nickel (Ni), copper (Cu), zinc (Zn), gallium (Ga), germanium (Ge), selenium (Se), strontium (Sr), yttrium (Y), zirconium (Zr), niobium (Nb), molybdenum (Mo), indium (In), lead (Pb), bismuth (Bi), antimony (Sb), tin (Sn), tungsten (W), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and an actinoid, for example.

The positive electrode active material may further include another component as long as it includes an olivine-type phosphate compound. This another component may include lithium-nickel composite oxide (LNO), lithium-cobalt composite oxide (LCO), lithium-manganese composite oxide (LMO), and/or the like, for example. The mixing ratio (in mass) between the olivine-type phosphate compound and the another component may be “(olivine-type phosphate compound)/(another component)=9/1 to 1/9”, or “(olivine-type phosphate compound)/(another component)=8/2 to 2/8”, or “(olivine-type phosphate compound)/(another component)=7/3 to 3/7”, or “(olivine-type phosphate compound)/(another component)=6/4 to 4/6”, for example. The positive electrode active material may be a mixture of powder of the olivine-type phosphate compound and powder of the another component, for example.

The LNO may have a crystal structure belonging to the space group R-3m, for example. The LNO may have a composition represented by the following general formula, for example.

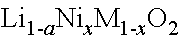

In the formula, the relationships of −0.5≤a≤0.5, 0≤x≤1 are satisfied. M may include, for example, at least one selected from the group consisting of Co, Mn, and Al. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1 may be satisfied. For example, the relationship of −0.4≤a≤0.4, −0.3≤a≤0.3, −0.2≤a≤0.2, or −0.1≤a≤0.1 may be satisfied.

The LNO may include at least one selected from the group consisting of LiNi_{0.9}Co_{0.1}O₂, LiNi_{0.9}Mn_{0.1}O₂, and LiNiO₂, for example.

The LNO may be represented by the following general formula, for example. A compound represented by the following general formula may also be called “NCM”.

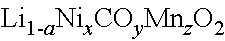

In the formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCM may include at least one selected from the group consisting of LiNi_{1/3}Co_{1/3}Mn_{1/3}O₂, LiNi_{0.4}Co_{0.3}Mn_{0.3}O₂, LiNi_{0.3}Co_{0.4}Mn_{0.3}O₂, LiNi_{0.3}Co_{0.3}Mn_{0.4}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, and LiNi_{0.9}Co_{0.05}Mn_{0.05}O₂, for example.

The LNO may be represented by the following general formula, for example. A compound represented by the following general formula may also be called “NCA”.

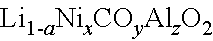

In the formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCA may include at least one selected from the group consisting of LiNi_{0.7}Co_{0.1}Al_{0.2}O₂, LiNi_{0.7}Co_{0.2}Al_{0.1}O₂, LiNi_{0.8}Co_{0.1}Al_{0.1}O₂, LiNi_{0.8}Co_{0.17}Al_{0.03}O₂, LiNi_{0.8}Co_{0.15}Al_{0.05}O₂, and LiNi_{0.9}Co_{0.05}Al_{0.05}O₂, for example.

### —Method of Producing Positive Electrode Active Material—

FIG. 4 is a schematic flowchart illustrating a method of producing a positive electrode active material according to the present embodiment. Hereinafter, “the method of producing a positive electrode active material according to the present embodiment” may be simply called “the present method”. The present method may comprise “(a) forming a slurry”, “(b) granulation”, and “(c) calcination”, for example.

### (a) Forming Slurry

The present method may include forming a slurry by mixing a lithium compound, a manganese compound, a phosphate compound, and a solvent. When the final product to produce is LMFP, an iron compound is added to the raw material mixture. For example, the lithium compound, the manganese compound, the phosphate compound, and the iron compound may be prepared in amounts that satisfy the composition ratio (in amount of substance) specified in the composition formula “Li₁₋ₐMn₁₋ₓFeₓPO₄ (−0.5≤a≤0.5, 0≤x<1)”. The lithium compound may include lithium hydroxide and/or the like, for example. The manganese compound may include manganese carbonate and/or the like, for example. The phosphate compound may include lithium dihydrogen phosphate and/or the like, for example. The iron compound may include ferric phosphate and/or the like, for example.

When it is intended to form a carbon layer on the surface of each primary particle, a carbon raw material is added to the raw material mixture. The carbon raw material may include a sugar, an organic acid, and/or the like, for example. The carbon raw material may include glucose, sucrose, fructose, citric acid, and/or the like, for example. The amount of the carbon raw material to be added in mass fraction relative to the raw material mixture may be from 1 to 20%, for example.

The solvent may include water and/or the like, for example. The solid concentration of the slurry in mass fraction may be from 20 to 40%, for example.

Wet grinding may be carried out to adjust the particle size in the slurry. For example, wet grinding may be carried out to achieve a D50 from 0.10 to 1 μm.

### (b) Granulation

The present method may include granulation, namely drying the slurry to produce secondary particles. For example, spray drying may be carried out for granulation to produce secondary particles. The size of the secondary particles as well as the proportion of secondary particles each having open pore may be adjusted by changing the settings of the spray dryer. According to a novel finding of the present disclosure, the temperature at the air inlet as well as the spray rate, in particular, may affect the proportion of secondary particles each having open pore. The temperature at the air inlet may be 220° C. or more, or 230° C. or more, for example. The temperature at the air inlet may be 240° C. or less, for example. The spray rate may be 16 mL/min or more, or 18 mL/min or more, for example. The spray rate may be 20 mL/min or less, for example.

The temperature at the air outlet may be from 100 to 130° C., for example. The air intake pressure may be approximately from 1.8 to 2.2 MPa, for example. The nozzle pressure of the spray nozzle may be from 0.1 to 0.3 MPa, for example.

### (c) Calcination

The present method may include performing heat treatment of the secondary particles to produce an olivine-type phosphate compound. Any heat treatment furnace (such as, for example, an electric furnace, a muffle furnace, and/or the like) may be used. The heat treatment atmosphere may be a nitrogen atmosphere, for example. The heat treatment temperature may be from 400 to 700° C., for example. The heat treatment time may be from 4 to 6 hours, for example.

### —Battery—

In some present embodiments, the battery has a monopolar structure. In some present embodiments, the battery has a bipolar structure. As an example, a battery having a bipolar structure (a bipolar battery) will be described.

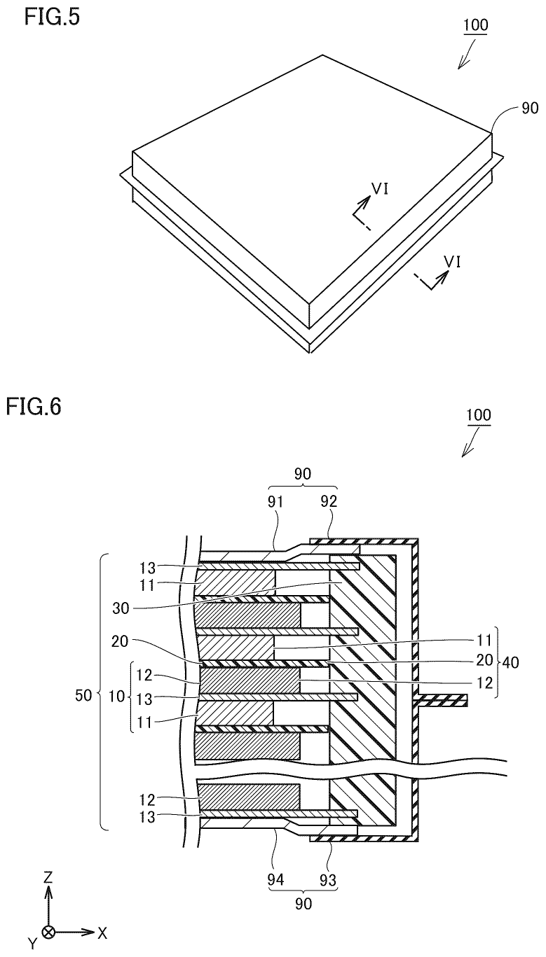

FIG. 5 is a schematic perspective view illustrating a battery according to the present embodiment. FIG. 6 is a schematic view of a cross section cut along the line VI-VI in FIG. 5. Hereinafter, “perpendicular-to-plane direction” refers to the direction of a normal to the surface of a sheet-form member (such as a foil sheet or an electrode, for example). “In-plane direction” refers to any direction that is orthogonal to the perpendicular-to-plane direction. In FIG. 6, the Z-axis direction corresponds to the perpendicular-to-plane direction. Each of the X-axis direction and the Y-axis direction is an example of an in-plane direction.

A battery 100 includes an exterior package 90 and a power generation element 50. Exterior package 90 accommodates power generation element 50. Exterior package 90 may include a first current collector plate 91, a first laminated film 92, a second laminated film 93, and a second current collector plate 94, for example. First laminated film 92 and second laminated film 93 are joined to each other at an end in an in-plane direction. At the joint portion between first laminated film 92 and second laminated film 93, a sealing material (not illustrated) may be interposed between first laminated film 92 and second laminated film 93.

At the ends in the stacking direction (the Z-axis direction), first current collector plate 91 and second current collector plate 94 are joined to power generation element 50, respectively. First laminated film 92 is joined to first current collector plate 91. Second laminated film 93 is joined to second current collector plate 94. At the joint portion between the current collector plate and the laminated film, a sealing material (not illustrated) may be interposed between the current collector plate and the laminated film.

Power generation element 50 includes a plurality of bipolar electrodes 10. Bipolar electrodes 10 are stacked in the perpendicular-to-plane direction (the Z-axis direction). In the perpendicular-to-plane direction, each bipolar electrode 10 includes a positive electrode layer 11, a current-collecting foil sheet 13, and a negative electrode layer 12 in this order. In an in-plane direction (for example, the X-axis direction), current-collecting foil sheet 13 extends outwardly beyond positive electrode layer 11 and negative electrode layer 12. For example, current-collecting foil sheet 13 may extend outwardly beyond positive electrode layer 11 and negative electrode layer 12 for the entire periphery in an in-plane direction.

Current-collecting foil sheet 13 is a conductor. For example, current-collecting foil sheet 13 may include a metal foil sheet, an electrically-conductive resin layer, and/or the like. For example, current-collecting foil sheet 13 may be formed by bonding an Al foil sheet and a Cu foil sheet together. A surface of current-collecting foil sheet 13 may have a carbon material applied thereto. The carbon material may include carbon black and/or the like, for example.

Power generation element 50 includes a sealing material 30. At an end in an in-plane direction, sealing material 30 is attached to current-collecting foil sheet 13. For example, sealing material 30 may be heat-sealed to current-collecting foil sheet 13. For example, sealing material 30 may be provided along the entire periphery in an in-plane direction. Sealing material 30 may include a resin material and/or the like, for example. Sealing material 30 seals interstices between current-collecting foil sheets 13 that are adjacent to each other in the perpendicular-to-plane direction. The interstices between current-collecting foil sheets 13 are thus sealed with sealing material 30, and thereby cells 40 are formed. A cell 40 is the smallest constituent unit of power generation element 50. Because it includes a plurality of cells 40, battery 100 may also be referred to as “a bipolar module”. Each of cells 40 is hermetically sealed. Cells 40 are segregated from each other. Each of cells 40 includes positive electrode layer 11, a separator 20, negative electrode layer 12, and an electrolyte solution.

### Positive Electrode Layer

Positive electrode layer 11 is adhered to one side of current-collecting foil sheet 13. For example, a groove may be formed in positive electrode layer 11. Positive electrode layer 11 may be formed in stripes, for example. Positive electrode layer 11 includes a positive electrode active material. That is, the electrode includes a positive electrode active material. The details of the positive electrode active material are as described above. The thickness of positive electrode layer 11 may be 10 μm or more, or 100 μm or more, or 200 μm or more, or 400 μm or more, or 600 μm or more, or 800 μm or more, or 1 mm or more, for example. The thickness of positive electrode layer 11 may be 1.2 mm or less, or 1 mm or less, or 800 μm or less, for example. At a thickness of 200 μm or more, for example, the influence of the liquid impregnation rate of the positive electrode active material may be markedly exhibited. In a bipolar structure, positive electrode layer 11 as thick as 200 μm or more may be desirable.

In addition to the positive electrode active material, positive electrode layer 11 may further include a conductive material, a binder, and the like, for example. The amount of the conductive material to be used may be, for example, from 0.1 to 10 parts by mass relative to 100 parts by mass of the positive electrode active material. The conductive material may include any component. The conductive material may include at least one selected from the group consisting of graphite, acetylene black (AB), Ketjenblack (registered trademark), vapor grown carbon fibers (VGCFs), carbon nanotubes (CNTs), and graphene flakes (GFs), for example.

The amount of the binder to be used may be, for example, from 0.1 to 10 parts by mass relative to 100 parts by mass of the positive electrode active material. The binder may include any component. The binder may include at least one selected from the group consisting of polyvinylidene difluoride (PVdF), vinylidene difluoride-hexafluoropropylene copolymer (PVdF-HFP), polytetrafluoroethylene (PTFE), carboxymethylcellulose (CMC), polyacrylic acid (PAA), polyvinyl alcohol (PVA), polyvinylpyrrolidone (PVP), polyoxyethylene alkyl ether, and derivatives of these, for example.

Positive electrode layer 11 may further include an inorganic filler, an organic filler, a solid electrolyte, a surface modifier, a dispersant, a lubricant, a flame retardant, a protective agent, a flux, a coupling agent, an adsorbent, and/or the like, for example. The positive electrode active material layer may include polyoxyethylene allylphenyl ether phosphate, zeolite, silane coupling agent, MoS₂, WO₃, and/or the like, for example.

### Negative Electrode Layer

Negative electrode layer 12 is adhered to one side of current-collecting foil sheet 13. Negative electrode layer 12 is positioned on the opposite side to the side on which positive electrode layer 11 is positioned. The area of negative electrode layer 12 may be greater than that of positive electrode layer 11. Negative electrode layer 12 includes a negative electrode active material.

The negative electrode active material may be in particle form, or may be in sheet form, for example. The D50 of the negative electrode active material may be 1 μm or more, or 5 μm or more, or 10 μm or more, for example. The D50 of the negative electrode active material may be 30 μm or less, or 20 μm or less, or 15 μm or less, or 10 μm or less, for example.

The negative electrode active material may include any component. The negative electrode active material may include at least one selected from the group consisting of carbon-based active material, alloy-based active material, Si—C composite material, Li metal, Li-based alloy, and lithium titanate, for example. In some present embodiments, the battery may be a Li-metal negative electrode battery.

The carbon-based active material may include at least one selected from the group consisting of graphite, soft carbon, and hard carbon, for example. The “graphite” collectively refers to natural graphite and artificial graphite. The graphite may be a mixture of natural graphite and artificial graphite. The mixing ratio (mass ratio) may be “(natural graphite)/(artificial graphite)=1/9 to 9/1”, or “(natural graphite)/(artificial graphite)=2/8 to 8/2”, or “(natural graphite)/(artificial graphite)=3/7 to 7/3”, for example.

The surface of the graphite may be covered with amorphous carbon, for example. The surface of the graphite may be covered with another type of material, for example. This another type of material may include at least one selected from the group consisting of P, W, Al, and O, for example. The another type of material may include at least one selected from the group consisting of Al(OH)₃, AlOOH, Al₂O₃, WO₃, Li₂CO₃, LiHCO₃, and Li₃PO₄, for example.

The alloy-based active material may include at least one selected from the group consisting of Si, Li silicate, SiO, Si-based alloy, tin (Sn), SnO, and Sn-based alloy, for example.

SiO may be represented by the following general formula, for example.

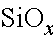

In the formula, the relationship of 0<x<2 is satisfied. For example, the relationship of 0.5≤x≤1.5 or 0.8≤x≤1.2 may be satisfied.

“Si—C composite material” refers to a composite material composed of a carbon-based active material (such as graphite) and an alloy-based active material (such as Si). For example, Si microparticles may be dispersed inside carbon particles. For example, Si microparticles may be dispersed inside graphite particles. For example, Li silicate particles may be covered with a carbon material (such as amorphous carbon).

### Separator

Separator 20 is capable of separating positive electrode layer 11 from negative electrode layer 12. Separator 20 is electrically insulating. Separator 20 may include at least one selected from the group consisting of a resin film (a polymer film), an inorganic particle layer, and an organic particle layer, for example. Separator 20 may include a resin film and an inorganic particle layer, for example.

The resin film is porous. The resin film may include a microporous film, a nonwoven fabric, and/or the like, for example. The resin film includes a resin skeleton. The resin skeleton may be continuous in mesh form, for example. Gaps in the resin skeleton form pores. The resin film allows an electrolyte solution to permeate therethrough. The resin film may have an average pore size of 1 μm or less, for example. The resin film may have an average pore size from 0.01 to 1 μm, or from 0.1 to 0.5 μm, for example. “Average pore size” may be measured by mercury porosimetry. The resin film may have a Gurley value from 50 to 250 s/100 cm³, for example. “Gurley value” may be measured by a Gurley test method.

The resin film may include at least one selected from the group consisting of an olefin-based resin, a polyurethane-based resin, a polyamide-based resin, a cellulose-based resin, a polyether-based resin, an acrylic-based resin, a polyester-based resin, and the like, for example. The resin film may include at least one selected from the group consisting of polyethylene (PE), polypropylene (PP), polyamide (PA), polyamide-imide (PAI), polyimide (PI), aromatic polyamide (aramid), polyphenylene ether (PPE), and derivatives of these, for example. The resin film may be formed by stretching, phase separation, and/or the like, for example. The resin film may have a thickness from 5 to 50 μm, or from 10 to 25 μm, for example.

The resin film may have a monolayer structure. The resin film may be made of a PE layer, for example. A skeleton of a PE layer is formed of PE. The PE layer may have shut-down function. The resin film may have a multilayer structure, for example. The resin film may include a PP layer and a PE layer, for example. A skeleton of a PP layer is formed of PP. The resin film may have a three-layer structure, for example. The resin film may be formed by stacking a PP layer, a PE layer, and a PP layer in this order, for example. The thickness of the PE layer may be from 5 to 20 μm, for example. The thickness of the PP layer may be from 3 to 10 μm, for example.

The inorganic particle layer may be formed on the surface of the resin film. The inorganic particle layer may be formed on only one side of the resin film, or may be formed on both sides of the resin film. The inorganic particle layer may be formed on the side facing the positive electrode layer 11, or may be formed on the side facing the negative electrode layer 12. The inorganic particle layer may be formed on the surface of positive electrode layer 11, or may be formed on the surface of negative electrode layer 12.

The inorganic particle layer is porous. The inorganic particle layer includes inorganic particles. The inorganic particles may also be called “an inorganic filler”. Gaps between the inorganic particles form pores. The inorganic particle layer may have a thickness from 0.5 to 10 μm, or from 1 to 5 μm, for example. The inorganic particles may include a heat-resistant material, for example. The inorganic particle layer that includes a heat-resistant material is also called “HRL (Heat Resistance Layer)”. The inorganic particles may include at least one selected from the group consisting of boehmite, alumina, zirconia, titania, magnesia, silica, and the like. The inorganic particles may have any shape. The inorganic particles may be spherical, rod-like, plate-like, fibrous, and/or the like, for example. The inorganic particles may have a D50 from 0.1 to 10 μm, or from 0.5 to 3 μm, for example. The inorganic particle layer may further include a binder. The binder may include at least one selected from the group consisting of an acrylic-based resin, a polyamide-based resin, a fluorine-based resin, an aromatic-polyether-based resin, and a liquid-crystal-polyester-based resin, and the like, for example.

Separator 20 may include an organic particle layer, for example. Separator 20 may include an organic particle layer instead of the resin film, for example. Separator 20 may include an organic particle layer instead of the inorganic particle layer, for example. Separator 20 may include both the resin film and an organic particle layer. Separator 20 may include both the inorganic particle layer and an organic particle layer. Separator 20 may include the resin film, the inorganic particle layer, and an organic particle layer.

The organic particle layer may have a thickness from 0.1 to 50 μm, or from 0.5 to 20 μm, or from 0.5 to 10 μm, or from 1 to 5 μm, for example. The organic particle layer includes organic particles. The organic particles may also be called “an organic filler”. The organic particles may include a heat-resistant material. The organic particles may include at least one selected from the group consisting of PE, PP, PTFE, PI, PAI, PA, aramid, and the like, for example. The organic particles may be spherical, rod-like, plate-like, fibrous, and/or the like, for example. The organic particles may have a D50 from 0.1 to 10 μm, or from 0.5 to 3 μm, for example.

Separator 20 may include a mixed layer, for example. The mixed layer includes both inorganic particles and organic particles.

### Electrolyte Solution

The electrolyte solution is a liquid electrolyte. The electrolyte solution includes a solute and a solvent. The concentration of the solute may be from 0.5 to 1 mol/L, or from 1 to 1.5 mol/L, or from 1.5 to 2 mol/L, or from 2 to 2.5 mol/L, or from 2.5 to 3 mol/L, for example. “Mol/L” may also be expressed as “M”. The solute includes a supporting salt (a Li salt). The solute may include an inorganic acid salt, an imide salt, an oxalato complex, a halide, and/or the like, for example. The solute may include at least one selected from the group consisting of LiPF₆, LiBF₄, LiClO₄, LiAsF₆, LiSbF₆, LiN(SO₂F)₂ “LiFSI”, LiN(SO₂CF₃)₂ “LiTFSI”, LiB(C₂O₄)₂ “LiBOB”, LiBF₂(C₂O₄) “LiDFOB”, LiPF₂(C₂O₄)₂ “LiDFOP”, LiPO₂F₂, FSO₃Li, LiI, LiBr, and derivatives of these, for example.

The electrolyte solution may include a carbonate-based solvent (a carbonate-ester-based solvent), for example. The solvent may include a cyclic carbonate, a chain carbonate, a fluorinated carbonate, and/or the like, for example. The solvent may include at least one selected from the group consisting of ethylene carbonate (EC), propylene carbonate (PC), butylene carbonate (BC), dimethyl carbonate (DMC), diethyl carbonate (DEC), ethyl methyl carbonate (EMC), monofluoroethylene carbonate (FEC), difluoroethylene carbonate, 4,4-difluoroethylene carbonate, trifluoroethylene carbonate, perfluoroethylene carbonate, fluoropropylene carbonate, difluoropropylene carbonate, and derivatives of these, for example.

The solvent may include a cyclic carbonate (such as EC, PC, FEC) and a chain carbonate (such as EMC, DMC, DEC). The mixing ratio between the cyclic carbonate and the chain carbonate (volume ratio) may be “(cyclic carbonate)/(chain carbonate)=1/9 to 4/6”, or “(cyclic carbonate)/(chain carbonate)=2/8 to 3/7”, or “(cyclic carbonate)/(chain carbonate)=3/7 to 4/6”, for example.

The solvent may include a cyclic carbonate (such as EC, PC) and a fluorinated cyclic carbonate (such as FEC). The mixing ratio between the cyclic carbonate and the fluorinated cyclic carbonate (volume ratio) may be “(cyclic carbonate)/(fluorinated cyclic carbonate)=99/1 to 90/10”, or “(cyclic carbonate)/(fluorinated cyclic carbonate)=9/1 to 1/9”, or “(cyclic carbonate)/(fluorinated cyclic carbonate)=9/1 to 7/3”, or “(cyclic carbonate)/(fluorinated cyclic carbonate)=3/7 to 1/9”, for example.

The solvent may include EC, FEC, EMC, DMC, and DEC, for example. The volume ratio of these components may satisfy the relationship represented by the following equation, for example.

$${V}_{EC} + {V}_{FEC} + {V}_{E M C} + {V}_{D M C} + {V}_{DEC} = 10$$

In the above equation, each of V_{EC}, V_{FEC}, V_{EMC}, V_{DMC}, and V_{DEC} represents the volume ratio of EC, FEC, EMC, DMC, and DEC, respectively.

The relationships of 1≤V_{EC}≤4, 0≤V_{FEC}≤3, V_{EC}+V_{FEC}≤4, 0≤V_{EMC}≤9, 0≤V_{DMC}≤9, 0≤V_{DEC}≤9, 6≤V_{EMC}+V_{DMC}+V_{DEC}≤9 are satisfied.

For example, the relationship of 1≤V_{EC}≤2 or 2≤V_{EC}≤3 may be satisfied.

For example, the relationship of 1≤V_{FEC}≤2 or 2≤V_{FEC}≤4 may be satisfied.

For example, the relationship of 3≤V_{EMC}≤4 or 6≤V_{EMC}≤8 may be satisfied.

For example, the relationship of 3≤V_{DMC}≤4 or 6≤V_{DMC}≤8 may be satisfied.

For example, the relationship of 3≤V_{DEC}≤4 or 6≤V_{DEC}≤8 may be satisfied.

The solvent may have a composition of “EC/EMC=3/7”, “EC/DMC=3/7”, “EC/FEC/DEC=1/2/7”, “EC/DMC/EMC=3/4/3”, “EC/DMC/EMC=3/3/4”, “EC/FEC/DMC/EMC=2/1/4/3”, “EC/FEC/DMC/EMC=1/2/4/3”, “EC/FEC/DMC/EMC=2/1/3/4”, “EC/FEC/DMC/EMC=1/2/3/4” (volume ratio), and/or the like, for example.

The electrolyte solution may include an ether-based solvent. The electrolyte solution may include at least one selected from the group consisting of tetrahydrofuran (THF), 1,4-dioxane (DOX), 1,3-dioxolane (DOL), 1,2-dimethoxyethane (DME), 1,2-diethoxyethane (DEE), hydrofluoroether (HFE), ethylglyme, triglyme, tetraglyme, and derivatives of these, for example.

The electrolyte solution may include any additive. The amount to be added (the mass fraction to the total amount of the electrolyte solution) may be from 0.01 to 5%, or from 0.05 to 3%, or from 0.1 to 1%, for example. The additive may include an SEI (Solid Electrolyte Interphase) formation promoter, an SEI formation inhibitor, a gas generation agent, an overcharging inhibitor, a flame retardant, an antioxidant, an electrode-protecting agent, a surfactant, and/or the like, for example.

The additive may include at least one selected from the group consisting of vinylene carbonate (VC), vinylethylene carbonate (VEC), 1,3-propane sultone (PS), tert-amylbenzene, 1,4-di-tert-butylbenzene, biphenyl (BP), cyclohexylbenzene (CHB), ethylene sulfite (ES), propane sultone (PS), ethylene sulfate (DTD), γ-butyrolactone, phosphazene compound, carboxylate ester [such as methyl formate (MF), methyl acetate (MA), methyl propionate (MP), diethyl malonate (DEM), for example], fluorobenzene (such as monofluorobenzene (FB), 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, for example), fluorotoluene (such as 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, octafluorotoluene, for example), benzotrifluoride (such as benzotrifluoride, 2-fluorobenzotrifluoride, 3-fluorobenzotrifluoride, 4-fluorobenzotrifluoride, 2-methylbenzotrifluoride, 3-methylbenzotrifluoride, 4-methylbenzotrifluoride, for example), fluoroxylene (such as 3-fluoro-o-xylene, 4-fluoro-o-xylene, 2-fluoro-m-xylene, 5-fluoro-m-xylene, for example), sulfur-containing heterocyclic compound (such as benzothiazole, 2-methylbenzothiazole, tetrathiafulvalene, for example), nitrile compound (such as adiponitrile, succinonitrile, for example), phosphate (such as trimethyl phosphate, triethyl phosphate, for example), carboxylic anhydride (such as acetic anhydride, propionic anhydride, oxalic anhydride, succinic anhydride, maleic anhydride, phthalic anhydride, benzoic anhydride, for example), alcohol (such as methanol, ethanol, n-propyl alcohol, ethylene glycol, diethylene glycol monomethyl ether, for example), and derivatives of these, for example.

The components described above as the solute and the solvent may be used as a trace component (an additive). The additive may include at least one selected from the group consisting of LiBF₄, LiFSI, LiTFSI, LiBOB, LIDFOB, LIDFOP, LiPO₂F₂, FSO₃Li, LiI, LiBr, HFE, DOX, PC, FEC, and derivatives of these, for example.

The electrolyte solution may include an ionic liquid. The ionic liquid may include at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives of these, for example.

In some present embodiments, the battery may include a gelled electrolyte. In other words, the battery may be a polymer battery. The gelled electrolyte may include an electrolyte solution and a polymer material. The polymer material may form a polymer matrix. The polymer material may include at least one selected from the group consisting of PVdF, PVdF-HFP, polyacrylonitrile (PAN), PVdF-PAN, polyethylene oxide (PEO), polyethylene glycol (PEG), and derivatives of these, for example.

### EXAMPLES

### —Production of Positive Electrode Active Material—

### No. 1

### (a) Forming Slurry

Lithium hydroxide monohydrate, manganese carbonate, ferric phosphate, and lithium dihydrogen phosphate were prepared in amounts that satisfied the composition ratio specified in the composition formula “Li_{1.04}Mn_{0.6}Fe_{0.4}PO₄”. Glucose was prepared in an amount of 8% in mass fraction relative to the total mass of the raw materials. The materials thus prepared and water were mixed together to form a slurry. The solid concentration of the slurry was 30% in mass fraction. Wet grinding was carried out to achieve a D50 of 0.30 μm.

### (b) Granulation

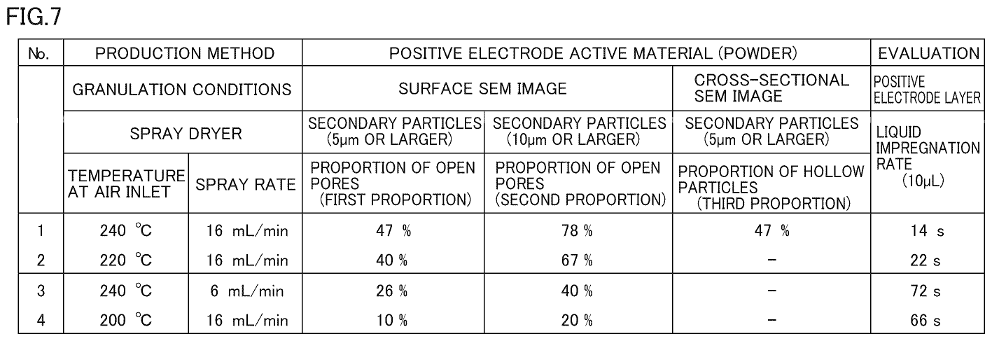

The slurry was spray dried to form secondary particles. The target value of the D50 of the secondary particles was 9±1 μm. FIG. 7 is a table showing experiment results. The settings of the spray dryer are as described in FIG. 7.

### (c) Calcination

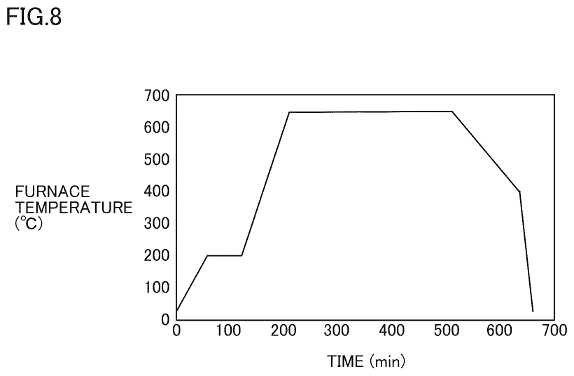

The secondary particles were calcined in a nitrogen atmosphere, and thereby LMFP was synthesized. FIG. 8 is a temperature profile during calcination. Firstly, the furnace temperature is raised at a temperature raising rate of 3° C./minute to reach 200° C. The furnace temperature is maintained at 200° C. for 1 hour. Then, the furnace temperature is raised at a temperature raising rate of 5° C./minute to reach 650° C. The furnace temperature is maintained at 650° C. for 5 hours. Subsequently, the furnace temperature is lowered at a temperature lowering rate of 2° C./minute to reach 400° C. Furthermore, the furnace temperature is lowered at a temperature lowering rate of 15° C./minute to reach room temperature.

### No. 2 to No. 4

Except that the granulation conditions (the settings of the spray dryer) were changed as specified in FIG. 7, the same operation as in No. 1 was carried out to produce positive electrode active materials.

### Evaluation

### Preparation of Electrode

The positive electrode active material, a conductive material (acetylene black) and a binder (PVdF) were mixed together to form a mixture. The mixing ratio (in mass) was “(positive electrode active material)/(conductive material)/binder=92/5/3”. The mixture was dispersed in a solvent (N-methyl-2-pyrrolidone) to form a paste. The solid concentration of the paste was 50% in mass fraction. The paste was applied to the surface of an Al foil sheet, followed by drying, and thereby a positive electrode layer was formed. The density of the positive electrode layer was adjusted to 1.8 g/cm³ with a roll press, and thereby an electrode was formed. The electrode was vacuum dried at 120° C. for 12 hours.

### Measurement of Liquid Impregnation Rate

By the procedure described below, the liquid impregnation rate was measured. A 10-μL micro syringe is filled with propylene carbonate (PC). A droplet formed at the tip of the syringe is brought into contact with the surface of the electrode (the positive electrode layer). The duration from immediately after the contact of the droplet to when the droplet on the surface of the positive electrode layer disappears (unit, seconds) is measured. This operation is repeated 3 times. The average value of these 3 operations is calculated. It is conceivable that the shorter the duration to droplet disappearance is, the faster the liquid impregnation rate is.

### Results

As seen in FIG. 7, when the proportion of secondary particles each having open pore to secondary particles each having a maximum Feret diameter of 5 μm or more in a surface SEM image of the powder, namely “the first proportion”, is 40% or more, the liquid impregnation rate tends to be markedly fast.

When the proportion of secondary particles each having open pore to secondary particles each having a maximum Feret diameter of 10 μm or more in a surface SEM image of the powder, namely “the second proportion”, is 70% or more, the liquid impregnation rate tends to be enhanced even more.

The proportion of hollow particles to secondary particles each having a maximum Feret diameter of 5 μm or more in a cross-sectional SEM image of the powder, namely “the third proportion”, agrees well with the first proportion.

What is claimed is:

1. A positive electrode active material comprising:
powder, wherein
the powder includes secondary particles,
each of the secondary particles includes primary particles,
each of the primary particles includes an olivine-type phosphate compound, and
in a scanning electron microscope image of the powder, a proportion of the secondary particles each having an open pore to the secondary particles each having a maximum Feret diameter of 5 μm or more is 40% or more.

2. The positive electrode active material according to claim 1, wherein
in the scanning electron microscope image of the powder, a proportion of the secondary particles each having an open pore to the secondary particles each having a maximum Feret diameter of 10 μm or more is 70% or more.

3. The positive electrode active material according to claim 1, wherein
in a scanning electron microscope image of a cross section of the powder, a proportion of hollow particles each having a hollow portion inside thereof to the secondary particles each having a maximum Feret diameter of 5 μm or more is 40% or more.

4. The positive electrode active material according to claim 1, wherein in a volume-based particle size distribution measured by laser diffraction,
D10 is less than 5 μm, and
D90 is more than 10 μm.

5. The positive electrode active material according to claim 1, wherein a ratio of a pore diameter of the open pore to the maximum Feret diameter of the secondary particle is 0.1 or more.

6. The positive electrode active material according to claim 1, wherein a maximum Feret diameter of the primary particle is from 10 to 90 nm.

7. The positive electrode active material according to claim 1, wherein the olivine-type phosphate compound includes lithium manganese phosphate.

8. An electrode comprising:
a positive electrode layer, wherein
the positive electrode layer includes the positive electrode active material according to claim 1.

9. A battery comprising:
the electrode according to claim 8; and
an electrolyte solution.

10. The battery according to claim 9, having a bipolar structure.
